(19) United States
(12) Patent Application Publication
(10) Pub. No.: US 2005/0083516 A1
(43) Pub. Date: Apr. 21, 2005

(54) Method and system for calibration of optics for an imaging device

(76) Inventor: Henry Harlyn Baker, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/690,378

(22) Filed: Oct. 20, 2003

(51) Int. Cl. G01B 9/00

(52) U.S. Cl. 356/124

(57) ABSTRACT

A method of calibrating and displaying images on a calibrated objective in autosteroscopy and other areas. Calibration includes receiving the objective over a raster-organized surface having both image display and image acquisition modalities, positioning a calibration model in a position before the system in preparation for acquiring images, receiving images of the calibration model onto raster-organized surface in an acquisition mode, identifying optical characteristics of objective through reference images of the calibration model. In addition, the method of displaying images using an objective includes receiving the objective over a raster-organized surface having both an image display and an image acquisition modalities, loading a calibration vector corresponding to the objective that compensates for optical characteristics of the objective and displaying images through the raster organized surface and objective compensated in accordance with the calibration vector for the objective.

### BACKGROUND OF THE INVENTION

The present invention relates to display technology. Advances in display technology have made high resolution displays widely available. To achieve this level of wide spread availability, advances have been made in the materials used to construct the display devices as well as the drivers and graphics processors used to render images on the devices. Display devices capable of delivering high resolution images are not limited to traditional, cathode-ray tub (CRT) but also include liquid crystal display (LCD), plasma screens and others. New display technologies also take advantage of high speed processors and advanced image processing methods to render images.

In addition to traditional display, these advanced materials and technologies have been applied to render images so that they appear three-dimensional rather than flat or two dimensional on the surface of the screen. There are two principal stereo or three-dimensional technologies for detached (i.e., not head-mounted) display. The first display technology presents two images on a screen and requires the observer or user to wear glasses that block one image or the other during viewing. The glasses include polarized glasses, colored glasses and shuttered glasses that selectively let different images pass through the glasses to each eye.

Autostereoscopic is a second type of technology that renders stereo or three-dimensional images without glasses. The autostereoscopic displays perform the three-dimensional imaging within the display without relying on other processing or peripheral equipment like glasses or eyewear. Instead, the displays are outfitted with an objective containing numerous refractory elements that direct different images to each eye of the observer. These autostereoscopic displays currently require the user to remain relatively still as the images are directed to different view zones corresponding to each eye. Further, the quality or resolution of the image is controlled by the resolution of the underlying display technology and the optical characteristics of the objective overlaying the surface of the display.

Unfortunately, the objectives used to perform autostereoscopic displays may have inherent defects, aberrations or impurities that degrade the images they produce in the autostereoscopic display. This not only affects the quality of the images but more importantly degrades autostereoscopic display as it is more difficult to control the direction in which the emitted energy moves through the objectives and into one or more view zones. Despite the inherent imperfections and drawbacks, conventional autostereoscopic displays continue to use these objectives having these inherent defects.

The relatively few people using these autostereoscopic display devices in various niche applications tolerate the relative expense, limitations of acuity and resolution the autostereoscopic devices can provide in exchange for stereo imaging. This will change as display resolution increases and the number of people using autostereoscopic systems grows. Eventually, the effect of these inherent defects will become more apparent and less tolerable as use of autostereoscopic displays becomes more commonplace. Indeed, more cost-effective design and production methods are needed if usage of autostereoscopic displays is to become widespread.

### BRIEF DESCRIPTION OF THE DRAWINGS

Features of the present invention and the manner of attaining them, and the invention itself, can be understood by reference to the following detailed description of embodiments of the invention, taken in conjunction with the accompanying drawings and schematics, wherein:

FIG. 1 is a block diagram overview of an system with applications capable of using autostereoscopic displays calibrated in accordance with the present invention;

FIG. 2A is a schematic diagram illustrating the principals of autostereoscopic viewing in accordance with the present invention;

FIG. 2B is a block diagram schematic detailing a raster organized surface and objective in accordance with one implementation of the present invention as used in a display device;

FIG. 2C is a block diagram schematic detail of subpixels operating to generate different images in corresponding view zones for a pair of viewing eyes;

FIG. 3 is a block diagram schematic for mounting and calibrating an objective in accordance with one implementation of the present invention;

FIG. 4 is a flowchart diagram providing the operations for calibrating an objective in accordance with one implementation of the present invention;

FIG. 5 is a flowchart diagram of the operations to calibrate an objective in accordance with one implementation of the present invention during image acquisition and generation;

FIG. 6 is a flowchart diagram of the operations for displaying images using an objective calibrated in accordance with the present invention; and

FIG. 7 is a block diagram of a system used in one implementation for performing the apparatus or methods of the present invention.

Like reference numbers and designations in the various drawings indicate like elements.

### SUMMARY OF THE INVENTION

One aspect of the present invention features a method of calibrating an objective. The calibration includes receiving the objective over a raster-organized surface having both image display and image acquisition modalities, positioning a calibration model one or more positions position before the objective and the raster-organized surface in preparation for acquiring images of the calibration model, receiving images of the calibration model through the objective and onto raster-organized surface in an acquisition mode, identifying optical characteristics of objective through a comparison of received images of the calibration model.

Another aspect of the invention includes a method of displaying images using an objective. The displaying of images includes receiving the objective over a raster-organized surface having both image display and image acquisition modalities, loading a calibration vector corresponding to the objective that compensates for optical characteristics of the objective when used in both a display mode and an acquisition mode and displaying images through the raster organized surface and objective compensated in accordance with the calibration vector for the objective.

### DETAILED DESCRIPTION

Aspects of the present invention are advantageous in at least one or more of the following ways. An optical objective (hereinafter an objective) used with a display device can be readily calibrated for improved resolution and reduced distortion caused by imperfections or aberrations in the objective. In autostereoscopic applications, the objective containing many micro refractive elements is placed over a raster organized surface to display images in three-dimensions. Calibration of the objective results in three dimensional images that have less distortion, appear more realistic and potentially cause less eye strain. In general, calibration of the objective is important as resolution of autostereoscopic and other display modes increase dramatically making imperfections more apparent and detrimental to the quality of the images being projected.

Calibrating the objective used in autostereoscopic and other displays also facilitates lower costs/unit as digital processing can compensate for imperfections in the objectives. Instead of discarding flawed objectives used in autostereoscopic and other applications, implementations of the present invention can be applied to compensate and accommodate for inherent aberrations or imperfections in the refractive portions of the objective. This effectively increases the yield of manufacturing these objectives without significant retooling or reconfiguring of existing manufacturing facilities.

Yet another benefit, implementations of the present invention calibrates an objective using a raster organized surface capable of both image display and image capture modalities. To calibrate the objective, the raster organized surface receives an object's image through the objective in image capture mode and then compares the results with other observations of the object. Inherent imperfections in the objective are noted and compensated in subsequent image capture and image display operations. This is advantageous as calibration can be achieved without complex additional cameras and feedback loops. Instead, the display having the dual mode capture and display modalities is able to measure the variation in the objective directly.

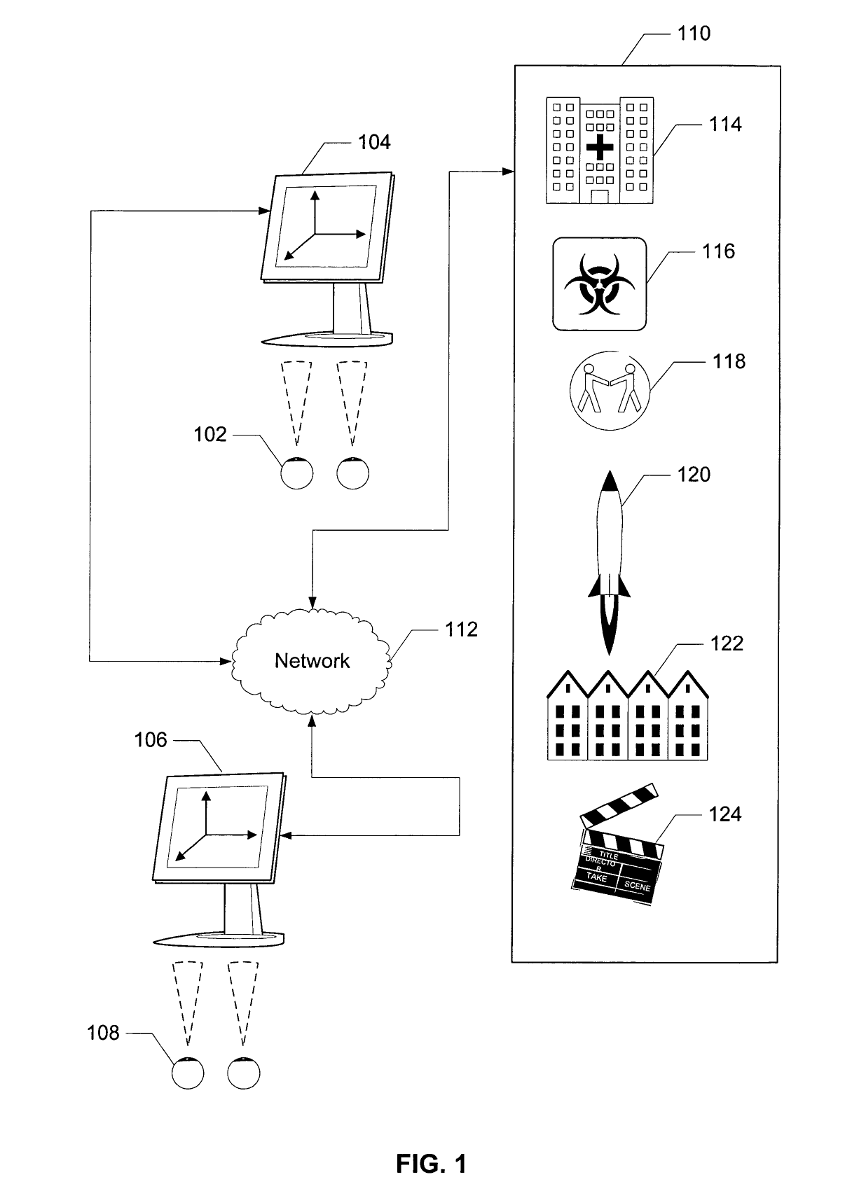

FIG. 1 is a block diagram overview of a system 100 with applications capable of using autostereoscopic displays calibrated in accordance with the present invention. Autostereoscopic displays provide three-dimensional viewing depending on a viewer's eye position rather than requiring the viewer to wear glasses or filters to block different image perspectives. In this example, system 100 includes first eyes 102, a first calibrated display 104, second eyes 106, a second calibrated display 108, applications 110 communicating over a network 112. Both first calibrated display 104 and second calibrated display 106 have an objective mounted over a raster organized surface having both an image display and image acquisition modalities. In one implementation, the objective on both first calibrated display 104 and second calibrated display 106 uses arrays of refractive elements configured as lenslets or lenticules to provide the autostereoscopic three-dimensional images to first eyes 102 and second eyes 106.

A first application includes a three-dimensional video system achieved by switching between image display and image acquisition modalities using displays nearest first eyes 102 and second eyes 106 respectively. The autostereoscopic implementation of the present invention allows first eyes 102 and second eyes 106 to be repositioned relative to their respective display and assume different viewpoints. People in video conference meetings with viewpoints of first eyes 102 or second eyes 106 may obtain different angles of facial expressions, gestures or other cues by moving eye location relative to the corresponding display rather than switching to cameras with different fixed perspectives. Calibrating the objectives in accordance with the present invention is important to presenting a consistent three-dimensional view even though nearby lenslets or lenticules used during operation have different inherent inconsistencies or aberrations. By calibrating and adjusting the image, stereoscopic images appear more consistent and realistic to parties viewing an autostereoscopic display.

Calibrating the refractive elements in accordance with the present invention also provides higher quality images than otherwise possible as inherent imperfections in the lenses are corrected in real-time as the images are acquired or displayed. Implementations of the present invention can also use eye tracking operations to identify areas of a display being viewed and increase resolution, reduce distortion, or suppress transmission outside of the localized area, rather than putting resources into all areas of the display uniformly.

Other applications 110 also benefit from calibration operations of the present invention as implemented in autostereoscopic displays and other displays using an objective. These other applications 110 include medical 114 (surgical simulation/training, surgical imaging and general imaging) hazardous materials 116 (managing relocation and disposal of hazardous waste), business 118 (presentations, financial 3D modeling, trade shows, reception areas/lobbies and industrial inspection), military 120 (simulations, training, heads-up displays, cockpit controls, satellite imaging, data reconnaissance and analysis), real estate 122 (virtual real estate tours, sales presentations, virtual property inspections and walk-through) and entertainment 124 (movie theatres, personal gaming devices and personal computer games).

In one or more of these applications, data gathering cameras and equipment collect information for three-dimensional representation which is then displayed in three dimensions on first calibrated display 104, second calibrated display 108 for eyes 102 or eyes 106 respectively and any other number of displays and viewing eyes. Of course, many other applications not specifically described herein that benefit from higher resolution images and three-dimensional viewing could also benefit by implementations of the present invention.

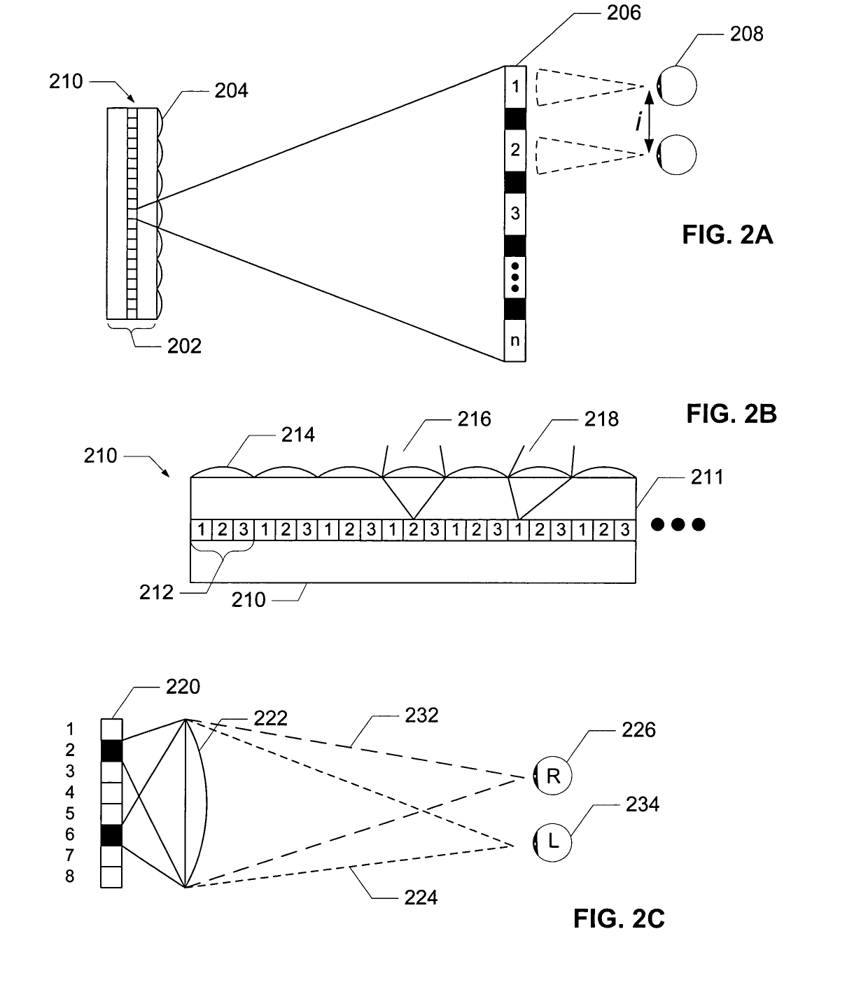

FIG. 2A is a schematic diagram, not drawn to scale, illustrating the principals of autostereoscopic viewing in accordance with the present invention. The autostereoscopic viewing schematic includes a display material 202 with objective 204, a set of view zones 206 and viewing eyes 208 having a particular intraocular distance (i) between the eyes.

In one implementation, display material 202 is composed from one or more different raster organized surface capable of operating in both an image display and an image acquisition modality. The raster organized surface can be constructed from adjacent emitting elements and sensing elements to perform the image display and image acquisition modalities respectively. For example, the emitting elements could be implemented using liquid crystal display (LCD) and light emitting diode (LED) components while the sensing elements could be constructed from photoreceptor materials.

Alternatively, the raster oriented surface could also be created using dual-purpose elements configured to perform both image display and image acquisition modalities under a control signal. In one implementation, the dual-purpose elements could be configured from an organic light emitting device (OLED) material that emits energy to perform image display under control of a first control signal and senses energy to perform image acquisition when under control from a second control signal.

In either of these or other implementations, objective 204 is a type of lens mounted on a raster display surface 202 that facilitates directing visual information to view zones 206 suitable for viewing eyes 208. To provide autostereoscopic viewing by viewing eyes 208, different colors or visual information are directed to different eyes thereby giving a three-dimensional effect to a person positioned at viewing eyes 208.

Objective 204 can be an array composed of many lenslet type refractive elements or many lenticule type refractive elements also arranged in an array structure. The lenslet shape corresponds to a slice of sphere and provides control over the refraction of light in two dimensions. In contrast, an objective having lenticules is also composed of an array or matrix of refractive elements but provides control over the refraction of light in essentially only one direction rather than two.

The number of view zones depends on the resolution of the underlying raster organized surface 202 and the ability for objective 204 to project regions in space, described as view zones, and into each eye of viewing eyes 208. In one implementation, the number of view zones projected corresponds to the number of subpixels in the set of subpixels corresponding to each lens of the objective. For example, the n view zones 206 corresponds to n subpixels for each lenslet or lenticule of objective 204.

Moreover, the number of view zones needed for autostereoscopic display also depends on the intraocular distance i between viewing eyes 208 and the ability for an autostereoscopic display to keep the correct view zone over the corresponding left or right eye as may be appropriate. On conventional systems, this would generally require that viewing eyes 208 remain fixed or not move beyond a very small range of a particular view zone, depending on the correctness of the optical elements.

However, an objective calibrated in accordance with the present invention is able to keep images projected into these view zones 206 positioned most appropriately for the viewer. Calibrated objectives of the present invention are able to better direct images to the correct eye of viewing eyes 208 even if viewing eyes 208 inadvertently move or shift to different pairs of view zones 206 or positions within view zones. With calibration of the present invention, more view zones seem present as the effective acuity in the objective is increased. Accordingly, viewing eyes 208 are less likely to detect a switch between lenslets or lenticules as the calibration reduces or eliminates imperfections or differences between the refractory elements and the images they produce between the view zones.

Further, combining calibration of the present invention with eye tracking features facilitates movement of viewing eyes 208 from one view zone to another without a characteristic jump, “black-out” or “null” area as the transition between view zones 206 takes place. By tracking eye location, implementations of the present invention can dynamically increase resolution or even the number of effective view zones 206 near or adjacent to the area being seen by viewing eyes 208. In effect, this allows individual view zones to take on the character of multiple view zones, with varying display dependent upon the position of the eye within the zone.

FIG. 2B is a block schematic diagram, not drawn to scale, detailing a raster organized surface and objective in accordance with one implementation of the present invention as used in a display device. This raster organized surface includes an upper plate 211, a bottom plate 210, a pixel 212 in a sequence of pixels having corresponding subpixels, an objective array 214, a first lenslet 216 and a second lenslet 218. As previously described the raster organized surface is capable of both image capture and image display characteristics using side-by-side elements or dual purpose elements.

In one implementation, semiconductor fabrication techniques are used to form pixel 212 and other pixels in the sequence upon bottom plate 210. In response to a bias signal or other control signal, one or more subpixels in pixel 212 direct different color values into areas of space. In this example, pixel 212 and other pixels have only three subpixels as indicated by the triplet of values (i.e., 123) however alternate implementations can have greater or fewer subpixels as needed depending on the number of view zones implemented.

To facilitate fabrication, objective 214 is a monolithic array of lenslets placed over the raster organized surface and calibrated in accordance with the present invention. Depending on the application, lenslets are manufactured and grouped into square, hexagonal or random shapes and secured to upper plate 211. Alternative implementations may fabricate the lenslet or lenticular array along with the semiconductor layer that lies beneath it. In this example, each lenslet in objective 214 projects three different view zones depending on the location and position of eyes in the view zone in the space over objective 214 as exemplified by first lenslet 216 or second lenslet 218. The light rays from first lenslet 216 provide colors from the 2^{nd} subpixel into a second view zone while the light rays passing through lenslet 218 provide colors from the 1^{st} subpixel into a first view zone. Other lenslets in objective 214 also contribute to the three different view zones but their contribution has been omitted in this example for purposes of explanation. In an alternative implementation, objective 214 is made up of one or more micro lenticules organized in a monolithic columnar array that refracts light in a single dimension.

FIG. 2C is a block schematic diagram detail of subpixels, not drawn to scale, operating to generate different images in corresponding view zones for a pair of viewing eyes. In FIG. 2C, pixel 220 has 8 subpixels providing a set of 8 different view zones through objective 222. Color from subpixel 2 in pixel 220 passes through lenslet 222 in a first view zone 224 towards a left eye 234 viewing a corresponding portion of the objective. Similarly, color from subpixel 6 in pixel 220 also passes through lenslet 222 generating a second view zone 232 towards a right eye 226 viewing a different portion of the objective. A stereoscopic three dimensional view is achieved from the two different view zones when the different colors projected towards each eye are combined together by the viewer.

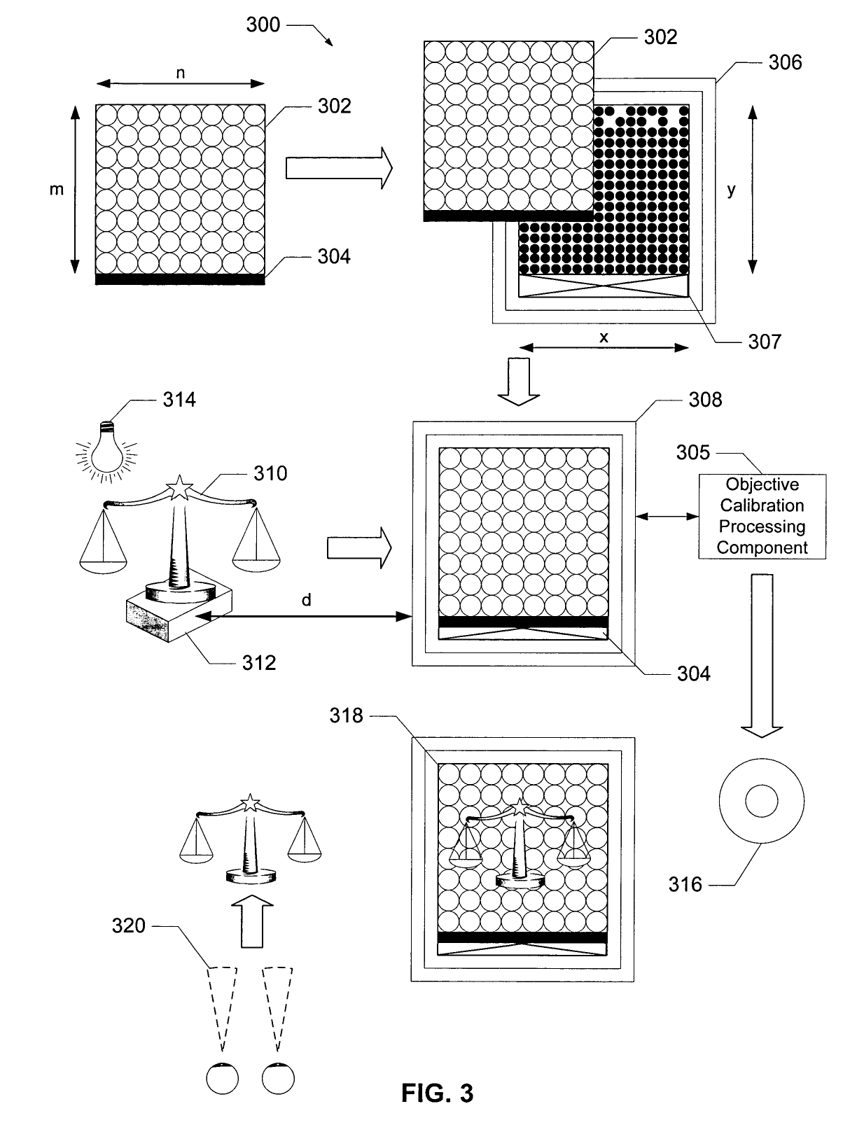

FIG. 3 is a block diagram schematic for mounting and calibrating an objective, not drawn to scale, in accordance with one implementation of the present invention. These block diagrams describe one process for both manufacturing and then calibrating an objective in accordance with the present invention. In this example, the objective includes m×n lenslets 302 arranged in a monolithic array along with a calibration storage area 304 for storing a calibration vector. Alternate implementations of the present invention can be created without calibration storage area 304 if an external storage solution is preferred. In either implementation, a device driver running on a computer loads the calibration vector from calibration storage area 304 or a CD-ROM once an autostereoscopic or other display device with the calibrated objective is coupled to the computer. The device driver uses the calibration vector in calibration storage area 304 or a CD-ROM specific to the objective to compensate for inherent optical errors and aberrations.

Lenslets 302 are mounted securely over a raster organized surface mount 306 by way of a frame and optionally an adhesive material if the mounting is to be permanent. Raster organized surface mount 306 has a communication port 307 to transmit calibration data to calibration storage area 304 of lenslets 302 by way of objective calibration processing component 305. In one implementation, raster organized surface mount 306 has X×Y raster elements grouped in pixels and subpixels to match lenslets 302 in a desired ratio between lenslets and pixels. Many different dimensional arrays of subpixels can be positioned beneath a variety of different lenslets or lenticules in an objective depending on the numerosity and type of view zones to be produced.

Objective and raster compound 308 are put in calibration mode in accordance with the present invention and presented with a calibration model 310 and light source 314. Raster elements are biased or otherwise given a control signal to record image of calibration model 310. Calibration model 310 is positioned at a variety of locations before the display and multiple views of are acquired. Objective calibration processing component 305 processes these views to determine the deviation of the objective's individual lenses from a perfect lens and generates a calibration vector reflecting this information. The calibration vector can be stored directly in calibration storage area 304 of lenslets 302 or externally in a CD-ROM 316, diskette or other storage to be shipped with the objective by the manufacturer. Once again, this calibration vector is loaded from storage by a device driver in a computer at a subsequent time period to compensate for the inherent errors of the objective used in an autostereoscopic or other type of display device.

In one implementation, an objective in objective and raster compound 308 is removed during manufacturing to make room for calibrating other objectives on raster organized surface mount 306. A first objective is calibrated and then distributed with calibration information for mounting on one or more different types of raster organized surfaces including LCD or LED surfaces as previously described. Alternatively, objective and raster compound 308 are not separated but sold as an integral unit for one or more different types of displays requiring calibrated objectives for higher resolution, quality imaging applications and improved autostereoscopic imaging.

Objective and raster compound 308 also has the ability to act as both an image display and image acquisition device. On occasion, a control signal sent to objective and raster compound 308 causes the raster surface to enter into image acquisition mode rather than an image display mode. Multiple images are obtained by the various pixels and subpixels under each lenslet or lenticules of the objective acting as small cameras.

The multiple images obtained have many uses. First, the multiple images can be superimposed to create images with super-resolution results and improve calibration operations in accordance with the present invention. Further, the super-resolution images can be used for highly accurate eye tracking of viewing eyes 320. Typical images can be greatly enhanced in accordance with the present invention by interlacing image acquisition for eye tracking with image display. For example, the eye location information is used to increase resolution of the autostereoscopic display especially in the areas that a viewer is observing the display. Even without super-resolution processing, the multiple different images can be transmitted to another person and viewing eyes receiving three-dimensional images over an autostereoscopic three dimensional video conferencing system or any other application that could use the multiple images acquired.

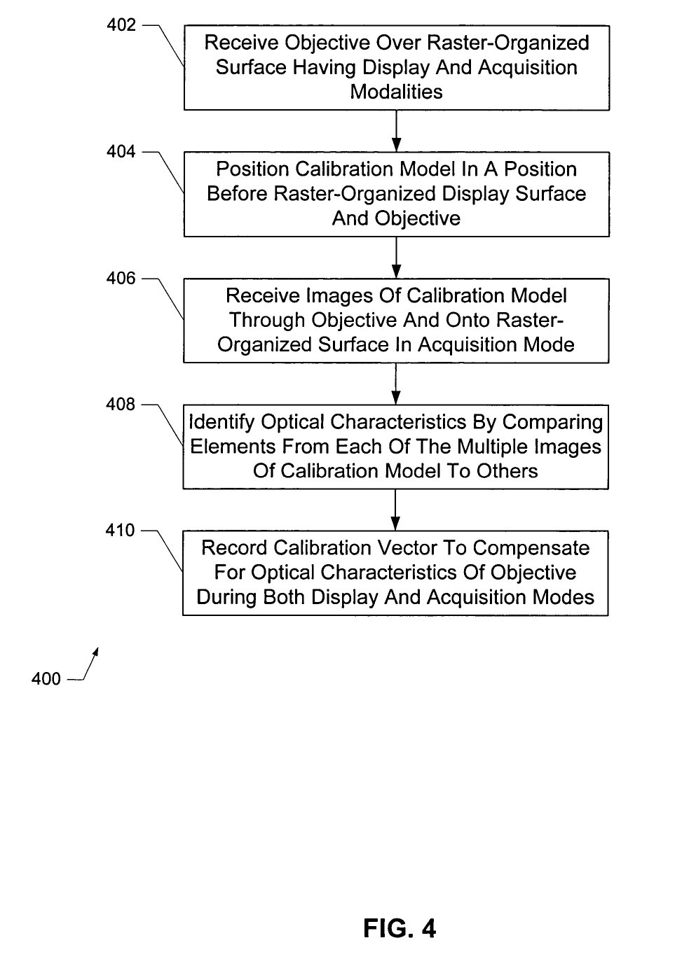

FIG. 4 is a flowchart diagram providing the operations for calibrating an objective in accordance with one implementation of the present invention. Initially, a raster-organized surface having display and acquisition modalities receives an objective for calibration (402). As previously described, the objective is securely mounted on raster organized surface to prepare for calibration and, if a permanent mounting is desired, an adhesive material is used in addition to a mechanical type mounting. In alternative implementations of the present invention, the lenslet or lenticular array may be fabricated along with the semiconductor layer that lies beneath it in an integral unit.

Next, implementations of the present invention then position a calibration model before the raster-organized display surface and objective (404). The calibration model is selected to best bring out imperfections or aberrations of the objective in accordance with the present invention. For example, the calibration model can be a Macbeth color chart or other calibration images well known in the art. Calibration may occur during manufacture or in other controlled environments to ensure the calibration is performed adequately and consistently. Alternatively, a user may perform calibration subsequent to manufacturing while installing the objective and display device onto a computer system. In either case, lighting as well as other conditions on the calibration model may need to be carefully maintained.

Once the calibration model is positioned, implementations of the present invention receive images of the calibration model through objective and onto raster-organized surface in acquisition mode (406). Multiple versions of the image are captured as images are received by the raster organized surface. Calibration comes from comparison of elements from each of the multiple image to all others (408). The calibration model is moved around before the system so as to cover as much of the field of view of the imagers as possible. Images collected are compared and contrasted with each other and processed during the calibration process to increase the accuracy of the measurements. These calculations are used to determine the calibration vector for all components of the objective.

For later use, implementations of the present invention record a calibration vector to compensate for optical characteristics of objective during both display and acquisition modes (410). The calibration vector includes information to compensate for specific lenslets or lenticules in the objective being measured and calibrated. For example, the calibration vector may identify lens distortion, focal length, and related optical and geometric properties of the lens system. This calibration vector can be multidimensional or even provide references to another database or other external reference with more information about the objective calibrated. As previously described, the calibration vector can be stored on the objective directly in a storage area or externally using a CD-ROM, floppy-diskette or other type of removable media.

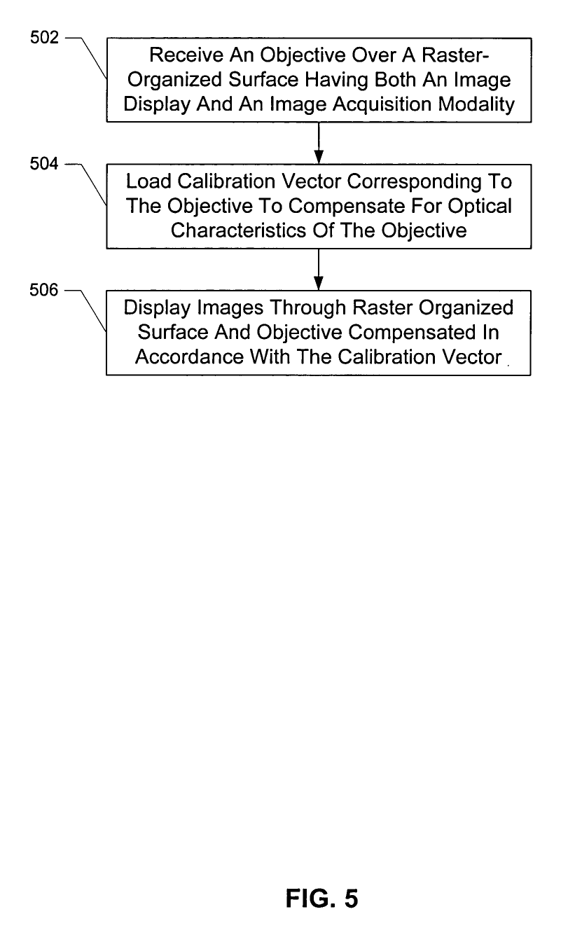

FIG. 5 is a flowchart diagram of the operations to calibrate an objective in accordance with one implementation of the present invention during image acquisition and generation. As previously described, the calibration information is gathered in advance during a calibration phase and then stored in a calibration vector or other storage area for subsequent usage. Before applying calibration information, an objective is secured over a raster-organized surface having both an image display and an image acquisition modality (502). One method of manufacturing autostereoscopic displays may involve separately calibrating the objectives during manufacture and then installing them over various raster organized surfaces (i.e., LCD, CRT, OLED based screens). This would facilitate separate manufacture and calibration of objectives and then a subsequent precision assembly of objectives over the various raster organized surfaces. Alternatively, the objective can be placed over the raster organized surface and then calibrated in situ with the objective and raster organized surface permanently affixed to one another. In many cases, it would be desirable to fabricate the lenslet or lenticular array along with the semiconductor layer that lies beneath it. These latter manufactured devices can then be used directly in video conference systems, entertainment, medical and other applications to display autostereoscopically or in other derivative display modalities.

In either of these or other implementations, the calibration operation loads a calibration vector corresponding to the objective to compensate for optical characteristics of the objective (504). As previously described the calibration vector stores particular optical characteristics of individual objectives and can take many different types of storage format. The vector can be a simply array, a matrix of values, a compact relational database or may even be an object within an hierarchical class structure for a complex object oriented driven database system.

In accordance with the present invention, the display of images through raster organized surface and objective are compensated in accordance with the calibration vector (506). For example, the images provided in an autostereoscopic display are altered in real-time as still or video images are presented and viewed by a pair of eyes from an observer. The effect is improved acuity of the still and/or video images as they are presented to and observed by one or more of the observers properly positioned in the several different view zones. Areas compensated for during calibration accommodate for variations in focal length, aspects ratios, skew characteristics, principal point and center of distortion, relative position and orientation in space as well as lens distortion, color quality, and any other deleterious influences on the image formation process.

Though often used in image display mode, a raster organized surface of the present invention on occasion switches to an image acquisition mode for various purposes. In a video conference system, image acquisition mode allows the raster organized surface to act as a camera for a moment and thereby allow parties to exchange visual information with little change in perspective—especially when compared with a remotely mounted and separate camera device; this also allows the video conference system to operate with a minimal amount of space and equipment. Additionally, the images acquired can be used to provide features related to multiviewpoint and eye tracking driven enhancements.

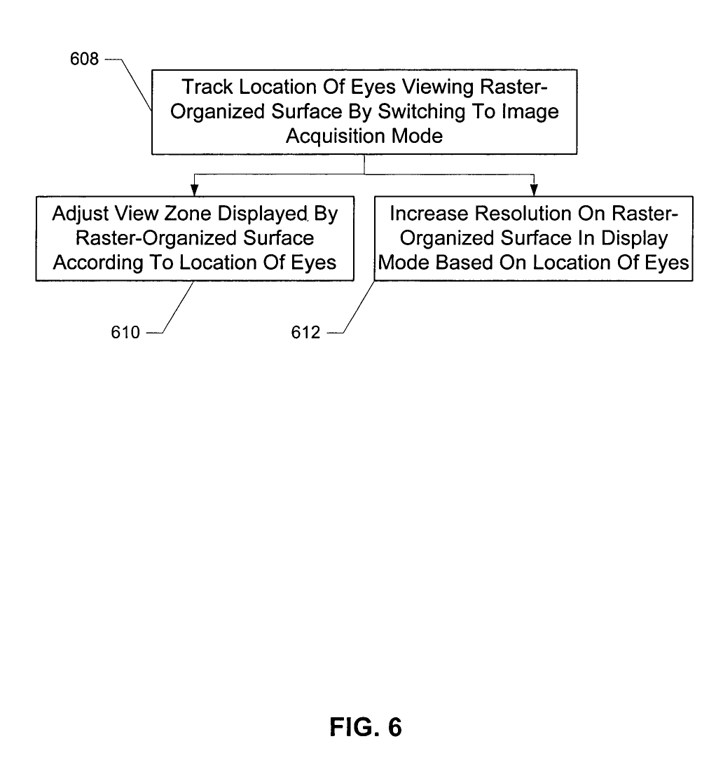

Other enhancements are also possible by tracking eye movement and displaying information based on the location of the eyes relative to the view zone in an autostereoscopic or other type of display. Accordingly, FIG. 6 is a flowchart diagram of the operations for displaying images using an objective calibrated in accordance with the present invention. In one implementation, the present invention tracks the location of eyes viewing raster-organized surface by switching to image acquisition mode (608). In one implementation, the locations of eyes are determined by combining visual information from multiple sensing pixels (imagers) and using image processing to identify and localize the eyes before the device. For example, important and useful values associated with eye tracking include measuring the distance and direction from the display device to the viewer's eyes.

Eye tracking results are used to then enhance portions of the image being generated. In one implementation, the view zone is adjusted and displayed by raster-organized surface according to the location of eyes (610). The content of view zones used in an autostereoscopic display can be adjusted to tailor the display to the locations of eyes viewing the screen. Colors and other images can be presented precisely where the eyes appear in the view zone based on the eye tracking information. This is an improvement over systems that present visual information at an average position in a view zone, with content that is unchanging throughout that zone.

Further, implementations of the present invention may also increase resolution on raster-organized surface in display mode based on the eye location information (612). This enhancement would increase the movement-observed resolution of view zones nearer to the detected eyes and give the effect of an increased number of view zones. Using the present invention to track the viewer's eyes reduces the likelihood that the viewer's eyes see discontinuous content at transitions between view zones and experience jerky percepts at those transitions. Because of the improved knowledge of both viewer eye position and the geometric character of the display function, the percept received more closely reflects the reality that is meant to be conveyed—inaccuracies or imprecisions in the three-dimensional nature of the display will be minimized.

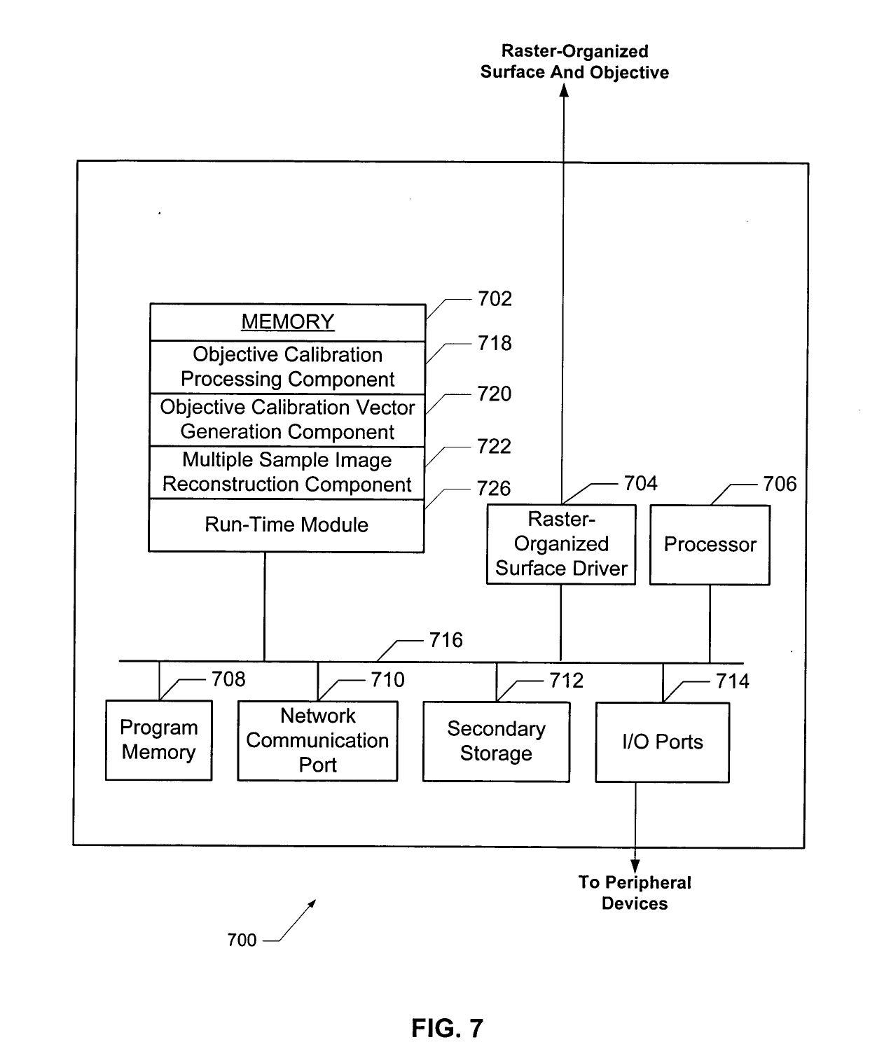

FIG. 7 is a block diagram of a system 700 used in one implementation for performing the apparatus or methods of the present invention. System 700 includes a memory 702 to hold executing programs (typically random access memory (RAM) or read-only memory (ROM) such as a flash RAM), a presentation device driver 704 capable of interfacing and driving a display or output device, a processor 706, a program memory 708 for holding drivers or other frequently used programs, a network communication port 710 for data communication, a secondary storage 712 with secondary storage controller, and input/output (I/O) ports 714 also with I/O controller operatively coupled together over a bus 716. The system 700 can be preprogrammed, in ROM, for example, using field-programmable gate array (FPGA) technology or it can be programmed (and reprogrammed) by loading a program from another source (for example, from a floppy disk, a CD-ROM, or another computer). Also, system 700 can be implemented using customized application specific integrated circuits (ASICs).

In one implementation, memory 702 includes an objective calibration processing component 718, objective calibration vector generation component 720, a multiple sample image reconstruction component 722, and a run-time module 726 that manages system resources used when processing one or more of the above components on system.

Objective calibration processing component 718 calibrates objectives in accordance with the present invention and as previously described. In operation, objective calibration processing component 720 analyzes the data and determines the calibration information to be associated with the objective. Multiple sample image reconstruction component 722 creates a single high quality image reconstructed or integrated from multiple slightly different copies of the image being received. This can be used for super-resolution as previously described.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

1. A method of calibrating an objective, comprising:
receiving the objective over a raster-organized surface having both image display and image acquisition modalities;
positioning a calibration model before the objective and the raster-organized surface in preparation for acquiring images of the calibration model;
receiving images of the calibration model through the objective and onto raster-organized surface in an acquisition mode;
identifying optical characteristics of objective through a comparison of received images of the calibration model.

2. The method of claim 1 further comprising:
recording a calibration vector corresponding to the objective that compensates for optical characteristics of the objective during both display and acquisition modes.

3. The method of claim 2 wherein the calibration vector is stored in a storage area associated with the objective.

4. The method of claim 2 wherein the calibration vector corresponding to the objective is stored on a storage device selected from a set of storage devices including: a CD-ROM, a DVD, a magnetic-tape, a floppy disc and a flash memory device.

5. The method of claim 1 wherein the objective is comprised of one or more lenslets that refract light in two dimensions.

6. The method of claim 5 wherein the one or more lenslets are organized in a monolithic array configuration.

7. The method of claim 6 wherein the lenslets in the monolithic array are organized into arrays selected from a set of shapes including a square shape, a hexagonal shape and a random shape.

8. The method of claim 5 wherein the lenslets facilitate autostereoscopic display when the raster organized surface operates in the image display modality.

9. The method of claim 1 wherein the objective is comprised of one or more lenticules that refract light in a single dimension.

10. The method of claim 9 wherein the one or more lenticules are organized in a monolithic columnar array.

11. The method of claim 9 wherein the lenticules facilitate autostereoscopic display when the raster organized surface operates in the image display modality.

12. The method of claim 1 wherein the raster oriented surface is comprised of adjacent emitting elements and sensing elements to perform the image display and image acquisition modalities respectively.

13. The method of claim 12 wherein the emitting elements are selected from a set including liquid crystal display (LCD), light emitting diode (LED), and other components, and the sensing elements include photoreceptors.

14. The method of claim 1 wherein the raster oriented surface is comprised of dual-purpose elements configured to perform both image display and image acquisition modalities under a control.

15. The method of claim 14 wherein the dual-purpose elements are configured from an organic light emitting device (OLED) material, or other material, that emits energy to perform image display when the control provides a first control signal and senses energy to perform image acquisition when the control provides a second control signal.

16. The method of claim 1 wherein the calibration model is an object presenting one or more different perspectives depending on the position of the objective on the raster oriented surface.

17. The method of claim 1 wherein receiving images of the calibration model, further comprises:
receiving one or more perspective views of the calibration model from one or more refractive elements of the objective.

18. A method of displaying images using an objective, comprising:
receiving the objective over a raster-organized surface having both an image display and an image acquisition modalities;
loading a calibration vector corresponding to the objective that compensates for optical characteristics of the objective when used in both a display mode and an acquisition mode; and
displaying images through the raster organized surface and objective compensated in accordance with the calibration vector for the objective.

19. The method of claim 18 wherein the objective is comprised of one or more lenslets that refract light in two dimensions.

20. The method of claim 19 wherein the one or more lenslets are organized in a monolithic array configuration.

21. The method of claim 20 wherein the lenslets in the monolithic array are organized into arrays selected from a set of shapes including a square shape, a hexagonal shape and a random shape.

22. The method of claim 21 wherein the lenslets facilitate autostereoscopic imaging when the raster organized surface operates in the image display modality.

23. The method of claim 18 wherein the objective is comprised of one or more lenticules that refract light in a single dimension.

24. The method of claim 23 wherein the one or more lenticules are organized in a monolithic columnar array.

25. The method of claim 23 wherein the lenticules facilitate autostereoscopic imaging when the raster organized surface operates in the image display modality.

26. The method of claim 18 wherein the raster oriented surface is comprised of adjacent emitting elements and sensing elements to perform the image display and image acquisition modalities respectively.

27. The method of claim 26 wherein the emitting elements are selected from a set including liquid crystal display (LCD) and light emitting diode (LED) components and the sensing elements include photoreceptors.

28. The method of claim 18 wherein the raster oriented surface is comprised of dual-purpose elements configured to perform both image display and image acquisition modalities under a control.

29. The method of claim 28 wherein the dual-purpose elements are configured from an organic light emitting device (OLED) material that emits energy to perform image display when the control provides a first control signal and senses energy to perform image acquisition when the control provides a second control signal.

30. The method of claim 18 further comprising,
tracking the location of eyes viewing an image generated by objective and raster-organized surface by switching to image acquisition mode; and
adjusting a view zone displayed by raster-organized surface according to the location of eyes.

31. The method of claim 18 further comprising,
incorporating the images displayed using the raster organized surface and objective in a video conference with another raster organized surface also having another corresponding objective.

32. A system for calibrating an objective, comprising:
a calibration model positioned before the objective and the raster-organized surface in preparation for acquiring images of the calibration model;
a raster-organized surface having both image display and image acquisition modalities configured to receive the objective that receives images of the calibration model through the objective and onto raster-organized surface in an acquisition mode; and
a processor capable of executing instructions that identify the optical characteristics of the objective through a comparison of received images of the calibration model.

33. The system of claim 32 further comprising:
a storage area associated with the objective for recording a calibration vector corresponding to the objective that compensates for optical characteristics of the objective during both display and acquisition modes.

34. The system of claim 33 wherein the calibration vector is stored in a storage area associated with the objective.

35. The system of claim 33 wherein the calibration vector corresponding to the objective is stored on a storage device selected from a set of storage devices including: a CD-ROM, a DVD, a magnetic-tape, a floppy disc and a flash memory device.

36. The system of claim 32 wherein the objective is comprised of one or more lenslets that refract light in two dimensions.

37. The system of claim 36 wherein the one or more lenslets are organized in a monolithic array configuration.

38. The system of claim 37 wherein the lenslets in the monolithic array are organized into arrays selected from a set of shapes including a square shape, a hexagonal shape and a random shape.

39. The system of claim 36 wherein the lenslets facilitate autostereoscopic display when the raster organized surface operates in the image display modality.

40. The system of claim 32 wherein the objective is comprised of one or more lenticules that refract light in a single dimension.

41. The system of claim 40 wherein the one or more lenticules are organized in a monolithic columnar array.

42. The system of claim 41 wherein the lenticules facilitate autostereoscopic display when the raster organized surface operates in the image display modality.

43. The system of claim 42 wherein the raster oriented surface is comprised of adjacent emitting elements and sensing elements to perform the image display and image acquisition modalities respectively.

44. The system of claim 42 wherein the emitting elements are selected from a set including liquid crystal display (LCD), light emitting diode (LED), and other components, and the sensing elements include photoreceptors.

45. The system of claim 32 wherein the raster oriented surface is comprised of dual-purpose elements configured to perform both image display and image acquisition modalities under a control.

46. The system of claim 45 wherein the dual-purpose elements are configured from an organic light emitting device (OLED) material, or other material, that emits energy to perform image display when the control provides a first control signal and senses energy to perform image acquisition when the control provides a second control signal.

47. The system of claim 32 wherein the calibration model is an object presenting one or more different perspectives depending on the position of the objective on the raster oriented surface.

48. An apparatus for calibrating an objective, comprising:
means for receiving the objective over a raster-organized surface having both image display and image acquisition modalities;
means for positioning a calibration model before the objective and the raster-organized surface in preparation for acquiring images of the calibration model;
means for receiving images of the calibration model through the objective and onto raster-organized surface in an acquisition mode; and
means for identifying optical characteristics of objective through a comparison of received images of the calibration model.

49. An apparatus for displaying images using an objective, comprising:
means for receiving the objective over a raster-organized surface having both an image display and an image acquisition modalities;
means for loading a calibration vector corresponding to the objective that compensates for optical characteristics of the objective when used in both a display mode and an acquisition mode; and
means for displaying images through the raster organized surface and objective compensated in accordance with the calibration vector for the objective.

50. An imaging device comprising:
an objective having an array of lenses mounted fixedly over a raster organized surface and a storage area holding a calibration vector capable of calibrating the lenses used in the objective.

51. The imaging device in claim 50 wherein the lenses are selected from a set including a lenslet and a lenticule.

52. The imaging device of claim 50 wherein the raster organized surface operates in a display mode and an image acquisition mode.

53. The imaging device of claim 50 used as an autostereoscopic display.
